(19) United States
(12) Patent Application Publication
(10) Pub. No.: US 2010/0156797 A1
(43) Pub. Date: Jun. 24, 2010

(54) COMPACT HANDSET COMMUNICATION AND PROCESSING DEVICE AND METHODS

(75) Inventor: Rajendra Kumar, Akron, OH (US)

Correspondence Address: SAND & SEBOLT, AEGIS TOWER, SUITE 1100, 4940 MUNSON STREET, NW, CANTON, OH, 44718-3615, US

(73) Assignee: KHYBER TECHNOLOGIES CORPORATION, Akron, OH (US)

(21) Appl. No.: 11/571,915

(22) PCT Filed: Jul. 15, 2005
(86) PCT No.: PCT/IB05/52366

§ 371 Date: Apr. 19, 2007

Related U.S. Application Data
(60) Provisional application No. 60/588,404, filed on Jul. 16, 2004.

(51) Int. Cl. G06F 3/02; G09G 5/00

(52) U.S. Cl. 345/169

(57) ABSTRACT

The present invention is directed to a handheld electronic device comprising one or two modules operatively interconnected via a pivotable connection mechanism or other moveable mechanical interconnection. Each module has two surfaces facing in opposing directions. The device further comprises a first display carried by a surface of a module, and possibly a text-entry keypad provided on a different surface. The text-entry keypad is optimized for entry of text via thumb-keying styled text-entry, wherein the user's hands cradle the device so the thumbs are in proper position for operation of the keypad. A navigation control may be provided on a surface of the module, and is sized and positioned to be operated by at least one finger or at least one thumb of the user's hands when cradling the device. There may also be provided for handset use, a second display sized substantially smaller than the first display, as well as a numerical entry keypad, an audio output port, an audio input port, or selective ones of such devices. These components can be provided on the surface of one of the two modules, such that these types of components remain uncovered and accessible in various configurations of the device.

### CROSS-REFERENCE TO RELATED APPLICATIONS/INCORPORATION BY REFERENCE

This application claims priority to U.S. provisional patent application Ser. No. 60/588,404 filed on Jul. 16, 2004, which is incorporated herein by reference in its entirety.

### TECHNICAL FIELD

The present invention relates to the field of handheld electronic devices, such as handheld communication or processing devices including cellular phones, and handheld computers with wireless communication and processing capabilities. More particularly, the present invention relates to handheld devices which provide simple handset-style voice communication, as well as more complex capabilities of text-entry and providing a large graphical user-interface and navigation control system to enhance use of the device.

### BACKGROUND OF THE INVENTION

There have been developed a number of handheld devices which combine cell phone and organizer capabilities into a single device, such as the model 9210 communicator produced by Nokia of Finland. This device for example, contains two sets of keyboard and display, one for use in a traditional handset mode where the device is held around the narrow dimension during voice communication, and a second set for entry of text for e-mails, and for operating the organizer portion of the device. The device can be used for voice communication in a handset-style configuration, as well as for text entry through a conventional Qwerty-style keyboard. At the same time, however, this and other similar units are too bulky and wide for comfortable handset-styled voice-communication, and for thumb-keying styled text-entry, such as made popular by the Blackberry line of products from Research in Motion of Canada.

There have also been developed by cell phone manufacturers, very compact wireless devices for handset-styled voice-communication, as well as other functions through a menu-driven graphical user interface. Such cell phones include single-module devices, such as the Model T610 produced by Sony Ericsson of Stockholm, Sweden, as well as clam-shell styled units such as the Motorola MPx200 and Samsung SCH-i600. Although useful for handset-styled voice-communication, these devices fail to offer the thumb-keying styled text-entry, made popular by the Blackberry line of products from Research in Motion of Canada and Treo products from palmOne.

The above-mentioned Blackberry and Treo line of products provide handset-styled voice-communication as well as thumb-keying styled text-entry. Although providing some advantages, the presence of the thumb-keypad makes the unit too wide for comfortable use in the handset mode, particularly as compared with conventional cell phones, which are optimized for handset-style voice communication.

There is thus a need for a device and methods wherein a compact and thin profile device provides for enhanced handset-style voice-communication, as well as providing more complex capabilities, such as text-entry and a large graphical user interface and navigation control system for enhanced ergonomics and ease of use.

### BRIEF SUMMARY OF THE INVENTION

Based upon the deficiencies of the prior art, it is therefore an object of the present invention to provide a device having a form factor for comfortable and convenient handset-style voice communication, as well as providing more complex capabilities of text-entry and a large graphical user interface, with these varying features and capabilities not being compromised relative to one another. The invention therefore overcomes limitations of the prior art, wherein the devices were deficient in form factor and/or function.

It is a further object of the invention to provide a compact and light-weight device, which has been optimized for both handset-style voice communication and comfortable and efficient text messaging as well as simple and effective navigation through a menu-driven graphical user interface.

In one aspect, the present invention is therefore directed to a handheld electronic device comprising two modules operatively interconnected via a pivotable connection mechanism or other moveable mechanical interconnection, wherein each module has two surfaces facing in opposing directions. The device further comprises a first display carried by a surface of one of the two modules, and a text-entry keypad provided on a surface of the other of the two modules. The text-entry keypad is optimized for entry of text via thumb-keying, wherein the user's hands cradle the device so the thumbs are in proper position for operation of the keypad. A navigation control may be provided on a surface of the module other than the surface carrying the text-entry keypad, wherein the navigation control is sized and positioned to be operated by at least one finger or at least one thumb of the user's hands when cradling the device, such as during text-entry by the user's thumbs. There may also be provided for handset use, a second display sized substantially smaller than the first display, as well as a numerical entry keypad, an audio output port, an audio input port, or selective ones of such devices. These components can be provided on the surface of one of the two modules, such that these types of components remain uncovered and accessible in various configurations of the device.

The moveable mechanical interconnection between the two modules may be of any suitable type, such as a planar motion mechanism allowing the modules to move in planar motion relative to one another, such as by sliding relative to one another or rotating relative to one another in a planar motion. Any other suitable mechanical interconnection which enables relative movement between the modules in the desired manner are contemplated, including a hinge mechanism. The navigation control associated with the device can comprise a touch pad, a plurality of navigation keys, or other suitable interface devices. The device may further comprise an imaging system for taking still and/or video images.

In an alternative embodiment of the invention, the handheld electronic device may comprise a single-module construction, wherein a first surface and a second surface are provided, facing in opposing directions. A first display is provided on the first surface, and a navigation control is provided on the second surface, wherein the navigation control is sized and positioned to be operated by at least one finger of the user's hands when the device is cradled by the user's hands with the first display facing the user. The display navigation control can comprise a touch pad, plurality of navigation keys, or other suitable interface components for manipulation by at least one finger or thumb of the user's hands when holding the device with the first display facing the user.

As a further alternative embodiment, the handheld electronic device according to the invention may comprise a single-module construction, having two opposing surfaces, with a first display provided on a first surface, and a second display provided on a second surface. The first display is sized substantially larger than the second display, and the device may further comprise handset features such as a keypad, as well as audio input and output ports. A navigation control is provided on one of the two surfaces, and a battery power supply is carried by the other of the two surfaces. The navigation control is sized and positioned to be operated by at least one finger or at least one thumb of the user's hands, when cradling the device with the first display facing the user. The display navigation control can comprise a touch pad, plurality of navigation keys, or other suitable interface for manipulation by at least one finger or at least one thumb of the user's hands.

These and other objects of the invention will become apparent upon a reading of the detailed description of embodiments thereof, in conjunction with the drawings.

### BRIEF DESCRIPTION OF THE DRAWINGS

FIG. 1 is a front view of an embodiment of a device in accordance with the present invention, showing the device in the open position for text-entry.

FIG. 2 is a back view of the embodiment shown in FIG. 1.

FIG. 3 is a top-end view of the device as shown in FIG. 1.

FIG. 4 is a top-end view of the device as shown in FIG. 2.

FIG. 5 is a left view of the device as shown in FIG. 2.

FIG. 6 is a front view of the device as shown in FIG. 1, except with the keypad closed.

FIG. 7 is a left view of the device as shown in FIG. 6.

FIG. 8 is a bottom-end view of the device as shown in FIG. 6.

FIG. 9 is a block diagram representation of an embodiment of the device according the invention.

FIG. 10 is a front view of a further embodiment of the present invention.

FIG. 11 shows a back view of the device shown in FIG. 10.

FIG. 12 shows a side view of the device as shown in FIG. 10.

FIG. 13 is a front view of a further embodiment of the present invention.

FIG. 14 shows a back view of the device shown in FIG. 13.

FIG. 15 shows a side view of the device shown in FIG. 13.

FIG. 16 is a front view of a further embodiment of the present invention.

FIG. 17 is a side view of the device shown in FIG. 16.

FIG. 18 is a back view of the device shown in FIG. 16 when folded.

FIG. 19 is a side view of the device shown in FIG. 18.

### DETAILED DESCRIPTION OF THE INVENTION

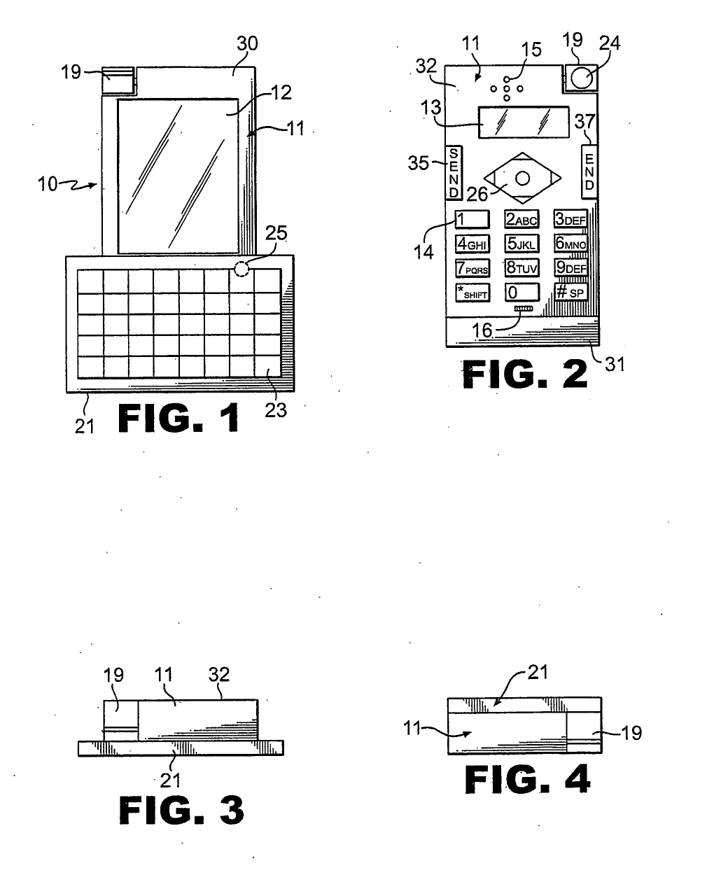

Turning now to the drawings, various embodiments according to the present invention are shown, and will be described hereafter. Although such embodiments are representative of the configuration, features and functionality of a handheld electronic device according to the invention, it is not limited to only such embodiments, as these embodiments are only exemplary of devices according to the invention. Turning to FIGS. 1-8, a handheld electronic device 10 according to an embodiment is shown. In this embodiment, the device 10 comprises first and second modules 11 and 21, which are interconnected via a movable, mechanical interconnection, such as a pivoting mechanism 25. In this embodiment, the pivoting mechanism 25 is a planar motion mechanism which allows modules 11 and 21 to rotate relative to one another about the pivot mechanism 25. Other suitable movable mechanical interconnections are also contemplated, and would occur to those skilled in the art, to enable relative motion between the modules 11 and 21, preferably by planar motion therebetween. An example of another suitable planar motion mechanism can be found in U.S. Pat. No. 5,638,257 of the Assignee, which is hereby incorporated by reference herein.

As shown in FIG. 1, module 21 may provide various functions in accordance with the device, and may comprise a text-entry keypad 23, which is designed for entry of text or other information using the thumbs of the hands when the device 10 is cradled in the user's hands. As seen in FIG. 1, when module 21 is moved to the position as shown in FIG. 1 relative to module 11, the keypad 23 is oriented to facilitate text-entry in this manner, with the long dimension of module 21 oriented perpendicular to the user's hands when cradled therein. The dimensions of the module 21 and therefore keypad 23 then allow simplified and more effective use of keypad 23 to facilitate this functionality of device 10. At the same time, when module 21 is oriented relative to module 11 in the manner as shown in FIG. 2, the keypad 23 is positioned in a stowed and out of the way location which does not interfere with other functionalities of the device 10.

It should also be seen that when keypad 23 is positioned in the orientation as shown in FIG. 1, a display 12 provided on the module 11 is exposed for viewing, with display 12 providing a large display to facilitate the text entry function that keypad 23 may be used for. The first display 12 is provided on a first surface 30 of module 11, and is selectively exposed by reorienting module 21 relative to module 11 as shown.

The module 11 may also include an imaging system 19, such as for still and/or video image capture, which may be of any suitable type known to those skilled in the art. As shown, the imaging system 19 may be configured to be pivotable or rotated about a mounting axis 22, for repositioning of a lens 24 associated with the imaging system 19, such as shown in FIGS. 2 and 5. Alternatively, the imaging system may be fixed, and device 10 held in proper orientation for capture of the image if desired, or another suitable mounting mechanism to allow imaging system 19 to be directed in a desired orientation for image capture.

Module 11 also has a second surface 32 opposed to first surface 30, which may be provided with handset components optimized for handset voice communications and functionality. As shown in this embodiment, the second surface 32 of module 11 may be provided with a second display 13, which is relatively smaller than first display 12, as well as a numeric entry keypad 14, an audio output port 15 and an audio input port 16. In addition, as shown in FIG. 2, the module 11 may also be provided with a navigation control system 26 provided on surface 32 of module 11. The navigation control system 26 enables the user to navigate through a menu-driven interface on the displays of device 10. In a desirable configuration, the navigation control 26 is sized and positioned to be operated by at least one finger or at least one thumb of the user's hands when the device 10 is cradled therein, and such that it can be manipulated by the user whether viewing first display 12 or second display 13. The navigation control 26 may be of any suitable configuration, and may comprise a touch pad or a plurality of navigation keys, joystick or the like, to facilitate manipulation by the user's fingers and/or thumbs. Additional control interfaces may also be provided in conjunction with module 11, accessible for manipulation by the user's fingers and/or thumbs on surface 32, such as communications send or end functions such as shown at 35 and 37. Further, device 10 comprises a battery supply 31, which may be carried in module 11 as shown in FIGS. 2 and 5, or otherwise provided to supply power to the various electrical components of the device 10. The battery supply 31 may thus be used to provide operational power for all components associated with each of the modules 11 and 21.

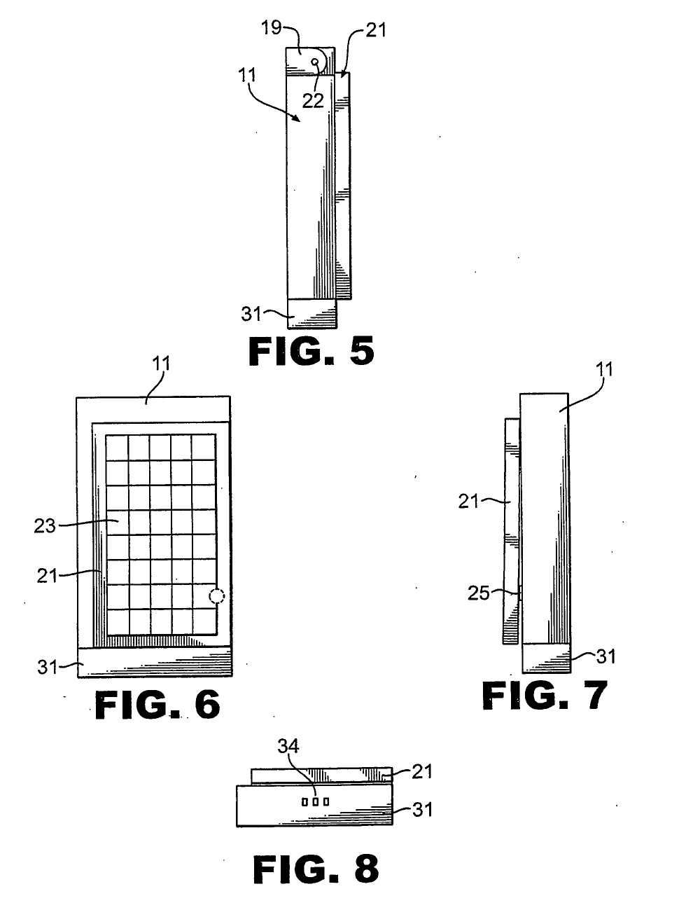

It should be recognized from a review of the embodiment shown in FIGS. 1-8, that the device 10 may be configured for use in at least functional modes of text-entry and data processing in the orientation as shown in FIGS. 1 and 3, as well as wireless handset communication when modules 11 and 21 are oriented in the manner such as shown in FIGS. 2 and 6. When module 21 is positioned in a “closed” position relative to module 11, such as shown in FIGS. 2 and 6, the display 12 associated with module 11 will be covered, and text-entry keypad 23 positioned to be out of the way. This provides a form factor for simple and effective wireless communication, in a similar configuration to a single module cell phone such as described in the Background of the Invention. At the same time, in both configurations, the navigation control 26 is provided for manipulation and control by the user using at least one finger or thumb of the user's hands, when the device 10 is cradled in a hand or the hands of the user. Thus, navigation control 26 provides for enhanced functionality in either of the wireless communication mode of the device 10 such as shown in FIGS. 2 and 6, or the text-entry operational mode such as shown in FIG. 1. As modules 11 and 21 are easily reoriented relative to one another, the operational modes of the device 10 can be quickly and easily engaged by the user.

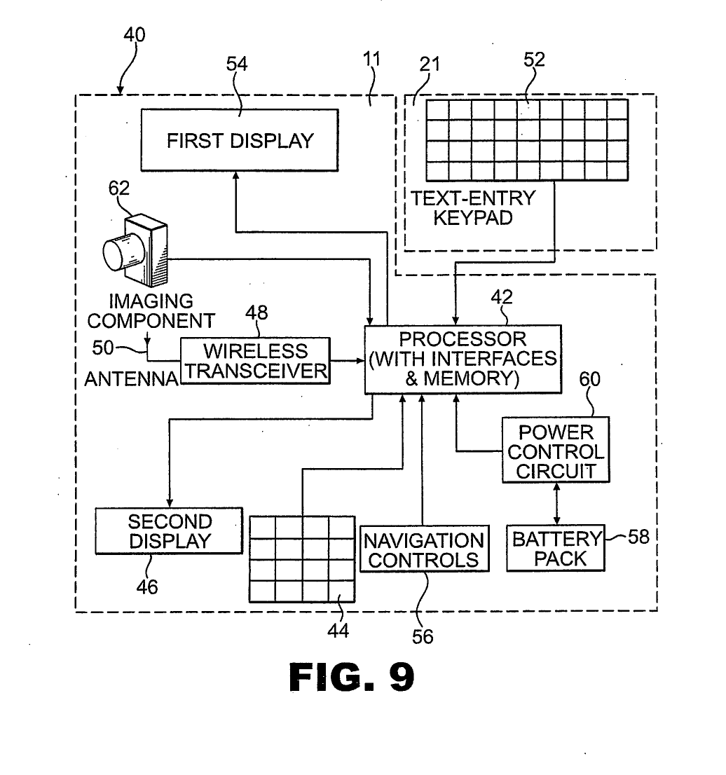

As mentioned previously, based upon the various functionalities provided by device 10, the second display 13, which may be used for simpler functions, such as displaying time and date, caller ID, phone numbers, other contact information or the like, the display 13 can be sized substantially smaller than the first display 12, which is designed to enhance text-entry or other functions of the device 10. Other suitable functions may also be integrated into the device 10, such as providing an interface 34, such as shown in FIG. 8, for connection of device 10 to other systems, such as a computer or a power source, for information exchange and/or recharging of the battery power supply 31.

Turning to FIG. 9, functions which may be associated with embodiments of the invention are shown. Such functions and systems are exemplary of embodiments according to the invention, but other functions may also be provided, as would occur to those skilled in the art. In the embodiment as shown in FIG. 9, a block diagram representation of the functions of a device 40 in accordance with an embodiment of the invention is shown. A processing system 42 may comprise a microprocessor, electrical interfaces to various input-output circuits, and associated memory for computer programs and data, or other suitable elements. For use of device 40 as a handset for wireless communication, the processor 42 may interact with a numeric-entry keypad 44, a display 46, and a wireless transceiver 48 with antenna 50, as an example. For text-entry functionality of device 40, the processing system 42 may interact with a text-entry keypad 52 and a display 54. For navigation through menu-driven graphical user interface or other suitable interface with such systems, the processing system 42 may allow input through the navigation controls 56, so as to allow operation in both the wireless communication handset and text-entry modes of operation. Other suitable systems, such as a power supply 58 and power control circuit 60 may be provided for operation of other systems. Further, other functionalities may be integrated into device 40, such as provision of an imaging system 62 for capture of still and/or video images. Other functionalities may also be provided, such as touch-screen interfaces associated with one or both of the displays 46 and 54, voice recognition system, audio recording system, or any other desired functions which would occur to those skilled in the art in association with a handheld electronic device according to the invention, used for communication, entertainment, processing, data storage or the like.

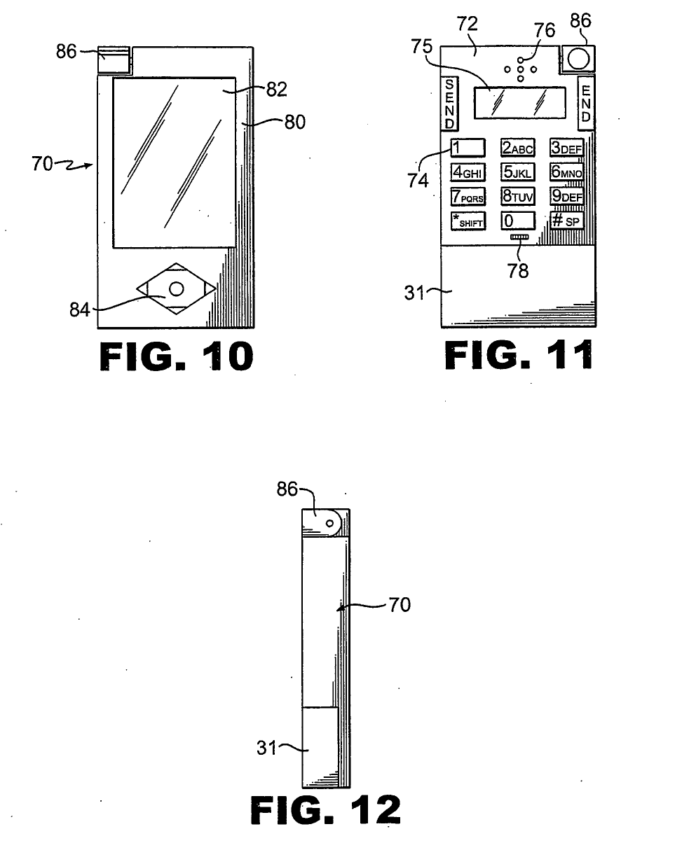

Turning now to FIGS. 10-12, an alternative embodiment of the invention is shown. In this embodiment, a device 70 is configured as a single-module device, which provides direct access to conventional handset capabilities on a first side 72 of the device 70. A numeric entry keyboard 74 may be provided along with audio output port 76 and input port 78 or the like. A battery power supply 80 may be provided in association with surface 72, to allow opposing surface 80 to be configured in a desired manner such as shown. In association with surface 80, a large display 82 is provided, along with navigation control 84. In this embodiment, device 70 therefore provides a large graphical user interface 82 by which information and functions can be accessed and used in an enhanced manner, with navigation control system 84 positioned for manipulation by at least one finger and/or thumb of a user's hands when device 70 is cradled in the hands. Thus, for use of device 74 entertainment purposes, the configuration allows much greater flexibility via this arrangement, as the user can access and manipulate data stored within device 70 in an enhanced manner. At the same time, the device 70 provides a form factor for wireless communication as a handset device, with navigation control system 84 again being positioned for easy manipulation by at least one finger and/or thumb of the user's hand when using device 70 as a handset. This will again allow easy access to data or other information via the display 75 provided on surface 72. Again, if desired, other functions may be integrated the device 70, such as an imaging system 86.

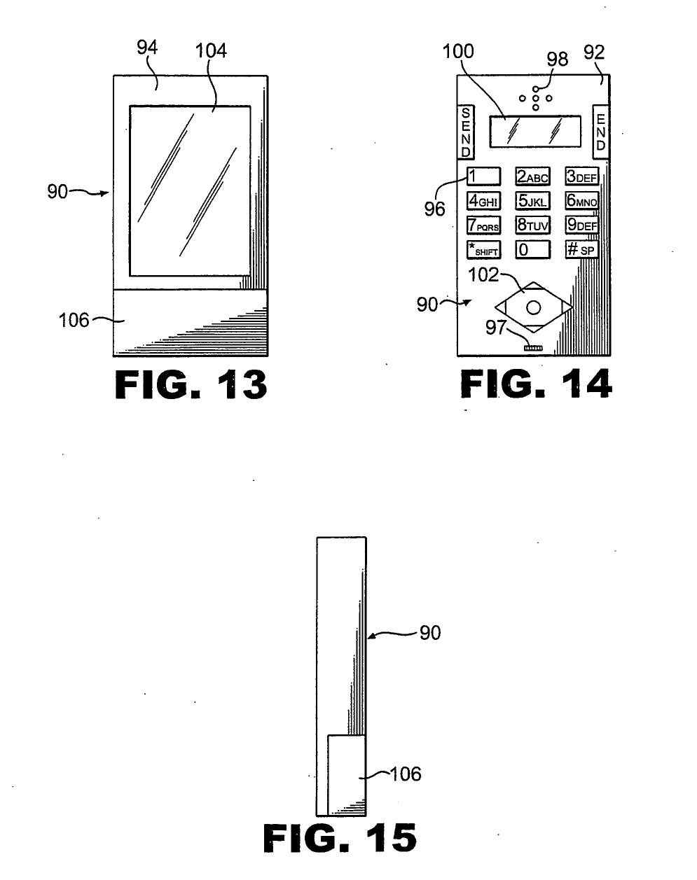

Turning now to FIGS. 13-15, an alternative embodiment is shown, wherein a single module design again provides direct access to conventional wireless communication handset capabilities on a first side, and enhanced functionalities via a navigation control system and alternative display associated therewith. In this embodiment, device 90 has a first side 92 and a second side 94, wherein handset functionalities are provided on side 92 for example. A numeric keypad 96, audio input port 97, and audio output port 98 may again be provided, along with a first display 100. In this embodiment, also associated with surface 92, navigation control system 102 is positioned for enhanced and simple manipulation by at least one finger and/or thumb of a user when device 90 is cradled in the hand or hands of the user. On opposing side 94 of device 90, a large display 104 may be provided, and as should be understood in this embodiment, allows manipulation of data or information via the graphical user interface 104 by use of navigation control system 102 provided on surface 92. Other suitable systems, such as a battery power supply 106 are provided, and any other suitable systems may be integrated into device 90, such as a camera or the like.

In the embodiments of FIGS. 10-12 and 13-15, the devices provide an extremely compact and comfortably used handheld system which allows more effective access to and manipulation of information, data, entertainment or other functions associated with the devices. The devices are compact, by means of locating handset components on a first side of the device, and a large graphical user interface display on an opposing side, thereby not requiring a clam shell construction, a longer length or a greater width. These embodiments also make the handset functions readily available to the user, without having to open a clam shell, or having to bring up an on-screen dial pad, for example. Ease of use also results from a conveniently located, large navigation control system in the embodiments, which is accessible in various modes of operation in association with one or both of the displays provided on the devices. The navigation controls allow easy manipulation using the thumbs or fingers in these embodiments, without impacting the size of the device.

The configurations of the invention as shown in these embodiments would also be useful in association with digital music players for example, wherein the positioning of navigation controls allows for a very compact and easily used device. This may thus be used as a stand-alone device for music, or the music player, such as MP3, iPod or like devices, may be integrated into a smart phone having this additional functionality, as an all-in-one communication and entertainment device. The navigation control positioning provides a more compact unit along with the text-entry keypad, for use in entering song names or other information.

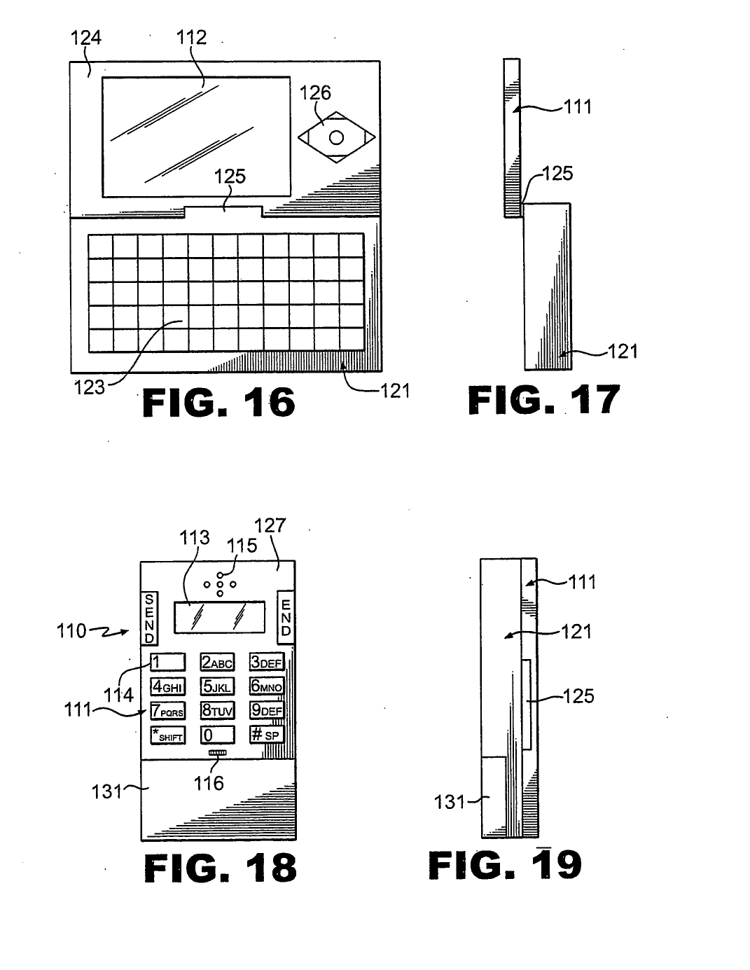

Turning now to the embodiment of FIGS. 16-19, a device 110 is shown, which is configured as a clam shell, or dual module device which is foldable or collapsible. A first module 111, and a second module 121 are operatively connected via a hinge mechanism 125, or other suitable mechanical interconnection, which allows folding or collapsing of modules relative to one another. The module 111 carries a first display 112, and a navigation control system 126 on a front surface thereof. The module 121 carries a text-entry keypad 123 on a front surface 124, and handset functions on the back surface 127 thereof. The handset functions may again comprise a numeric entry keypad 114, an audio output port 115, an audio input port 116, and a second display 113. The second display 113, which may be used for simpler functions such as displaying time and date, caller ID, contact information or the like, is sized substantially smaller than the first display 112. Similar to the embodiment of FIG. 1, each of these functionalities is enhanced by providing a compact and light-weight device, which allows for handset style voice communication, as well as comfortable text messaging and navigation through a menu-driven graphical user interface. The navigation system is again provided in a manner to allow for simplified manipulation in various modes of operation, and allows manipulation by one or more fingers and/or thumbs of the user's hands when the device 110 is cradled within a hand or hands of the user. Various aspects of this embodiment are thus understood with reference to prior embodiments as described, all in accordance with the novel aspects of the present invention.

Inasmuch as the present invention is subject to variations, modifications, and changes in detail, some of which have been expressly stated herein, it is intended that all matter described throughout this entire specification or shown in the accompanying drawings be interpreted as illustrative and not in a limiting sense. The invention is therefore defined according to the following claims. It should thus be evident that a device constructed according to the concept of the present invention, and reasonably equivalent thereto, will accomplish the objects of the present invention and otherwise substantially improve the art of handheld devices that provide simple handset-style voice communication as well as more complex capabilities of text-entry and graphical user-interface without compromising the effectiveness of one set of capabilities over the other.

1. A handheld electronic device comprising:
first and second modules each having first and second surfaces facing in opposing directions, and being operatively interconnected via a pivot mechanism;
a first display provided on a first surface of one of the modules, and a text-entry keypad provided on a surface of the other of the two modules, wherein the text-entry keypad is positioned for entry of text by the thumbs of the user's hands when cradling the device;
a navigation control system carried by one of the surfaces distinct from the surface provided with the text-entry keypad, wherein the navigation control system is sized and positioned to be operated by one of at least one finger or at least one thumb of the user's hands when holding the device with the first display facing the user;
a second display provided on a surface distinct from the first display, in conjunction with handset functions including at least an audio input port and output port.

2. A device according to claim 1, wherein the first display is selectively covered by a surface of the other module.

3. A device according to claim 1, wherein the pivot mechanism is one of a planar motion mechanism and a hinge mechanism.

4. A device according to claim 1, wherein the navigation control system comprises at least one of a touch pad and a plurality of navigation keys.

5. A handheld electronic device comprising:
a single module having first and second opposing surfaces;
a first display provided on the first surface, and the second surface carrying a navigation control system, wherein the navigation control system is sized and positioned to be operated by at least one finger of the user's hands when holding the device with the first display facing the user.

6. A device according to claim 5, wherein the navigation control system comprises at least one of a touch pad and a plurality of navigation keys.

7. A handheld electronic device comprising:
a single module having first and second opposing surfaces;
one of the first and second surfaces provided with a first display, and the other of the surfaces provided with a second display and handset functions comprising at least an audio input and output port;
a navigation control system provided on a surface, wherein the navigation control system is sized and positioned to be operated by one of at least one finger and at least one thumb of the user's hands when holding the device with the first display facing the user.

8. A device according to claim 7, wherein the navigation control system comprises at least one of a touch pad and a plurality of navigation keys.

9. A device according to claim 7, wherein the handset functions further comprise a numeric entry keypad.

10. A device according to claim 7, wherein the navigation control system comprises at least one of a touch pad and a plurality of navigation keys.
